(19) United States
(12) Patent Application Publication
(10) Pub. No.: US 2019/0127392 A1
(43) Pub. Date: May 2, 2019

(54) QUANTUM DEVICES COMPRISING LANTHANIDE COMPLEXES

(71) Applicant: YEDA RESEARCH AND DEVELOPMENT CO. LTD., Rehovot (IL)

(72) Inventors: Barak DAYAN, Tel Aviv (IL); Abraham SHANZER, Rehovot (IL); Ori Ezrah MOR MARKOVSKY, Rehovot (IL)

(73) Assignee: YEDA RESEARCH AND DEVELOPMENT CO. LTD., Rehovot (IL)

(21) Appl. No.: 16/168,863

(22) Filed: Oct. 24, 2018

Related U.S. Application Data
(60) Provisional application No. 62/590,718, filed on Nov. 27, 2017.
(60) Provisional application No. 62/577,371, filed on Oct. 26, 2017.

(51) Int. Cl. C07F 5/00; G06N 99/00

(52) U.S. Cl. CPC C07F 5/003; G02B 2006/12111; G06N 99/002

(57) ABSTRACT

A quantum device for interfacing Lanthanide ions with optical fields or microwave fields or both. The device includes waveguides or resonators or both for optical fields or microwave fields or for both. The device includes at least one surface to which a single customized Lanthanide molecular complex, or an ensemble, layer, multilayer or crystal of such, are attached or bonded. This places the Lanthanide ions within the optical or microwave fields or both. The ability to customize the molecular structure around each Lanthanide ion, and to control their orientation and position and nano-environment in general, enables minimizing the host lattice effects and non-radiative loss channels for each ion, and increasing their homogeneity. Accordingly, the advantages of the present invention include reduced inhomogeneities, narrower linewidths, extended fluorescence and coherence times, and higher operation temperatures. Devices which benefit from the present invention include lasers, amplifiers, sensors, quantum memories, repeaters and quantum information processing devices at optical fields, microwave fields, or both, including bi-directional optical-microwave convertors.

### CROSS REFERENCE TO RELATED APPLICATIONS

This application claims the benefit of U.S. Ser. No. 62/577,371, filed on Oct. 26, 2017, and of application Ser. No. 62/590,718, filed on Nov. 27, 2017 which are incorporated in their entirety herein by reference.

### BACKGROUND OF THE INVENTION

Lanthanide (Rare-Earth) doped laser crystals and glasses are among the most common solid-state gain media. Lanthanide Rare-Earth ions nearly always exhibit a triple positive charge (trivalent ions). A characteristic property of rare-earth ions is their intra 4f (4f-4f) electronic transitions which are somewhat shielded from the host lattice by the optically passive outer closed electronic shells, 5s and 5p, which tends to reduce the influence of the host lattice on the wavelengths, bandwidths, and cross sections of the relevant optical transitions. The shielded f-f transitions of lanthanides are the basis for solid state lasers, amplifiers and sensors, and have great potential as a platform for quantum communication and computation systems.

Currently, the most important of the lanthanide-based gain media include Ytterbium and Neodymium lasers (e.g., Nd:YAG lasers) and Erbium-doped fibers for fiber amplifiers, lasers and sensors.

Their relatively isolated f-f transitions make lanthanides promising building blocks for quantum communication and computation systems. Additionally, the presence of microwave hyperfine resonances also allows coupling lanthanides to superconducting circuits and qubits, for handling quantum information. Specifically, there is a need for solid-state quantum emitters that are more scalable than cold atoms or ions, such as NV centers and quantum dots. Rare-earth ions offer promise both for single material qubits and quantum communication, where ensembles of ions can serve as a collective photonic memory.

Unfortunately, there are currently available only two kinds of hosts for Lanthanide ions for use in lasers, amplifiers, sensors and quantum devices: doped bulk crystals and doped bulk glass, both of which have shortcomings, as detailed below:

Lanthanide hosts for the above-referenced applications are typically from the following limited selection:
crystals, usually Yttrium-based, such as Yttrium Aluminum Garnet (YAG), Yttrium Lithium Fluoride (YLF), or Yttrium orthovanadate (YVO₄, often abbreviated as YVO); and
silica optical fibers;
   into which the lanthanide ions are deposited or implanted as dopants into the bulk material.

Neither of the above dopant hosts have ideal properties for the above-referenced device applications. The doping process results in significant inhomogeneous spectral broadening; and coupling to phononic bands leads to decoherence and phononic broadening. Although doped optical fibers offer more convenient coupling and guiding of light compared to crystals, the amorphous silica of the fibers results in even larger inhomogeneity and spectral diffusion due to dynamic changes in the position of neighboring atoms that freeze only at temperatures below 100 mK.

The above shortcomings significantly impact the ability to incorporate lanthanide ions in optical fibers and other devices. Both phononic coupling and inhomogeneity are much more crucial at low powers, especially at the single-photon levels involved in quantum applications—in this domain, cryogenic cooling is required to reduce the temperature below 10K in crystals, and below 100 mK in doped glasses such as silica fibers. Furthermore, to increase the electric field associated with even a single photon, quantum applications typically require tiny mode areas of the optical mode, even below the area of the core of optical fibers. Focusing in free space into a spot inside bulk crystals is problematic, as the effective high-intensity volume is small compared to the propagation losses in the crystal on the way in and out. Etching waveguides in such crystals is difficult, so the approach generally taken is to use nanocrystals placed at the focus of lenses or resonators. However, nanocrystals exhibit distributions in their size, surface state, charge, and other properties, leading to even larger inhomogeneities and consequent spectral diffusion effects, reducing the desirability of such nanocrystals as quantum emitters.

Consequently, there is a need for incorporating lanthanide ions in lasers, amplifiers, sensors, waveguides, resonators, and other quantum devices without incurring the drawbacks discussed above. In particular: operation without heavy cryogenic cooling; avoidance of spectral broadening; and, in general, improved immunity from non-radiative (e.g., phononic) energy losses. These goals are met by embodiments of the present invention.

### SUMMARY OF THE INVENTION

Embodiments of the present invention provide waveguides, resonators, and the like, which include lanthanide complexes adsorbed or, covalently bound to a surface rather than as bulk-volume dopants, thereby avoiding the restrictions discussed above. Certain embodiments of the invention operate in the microwave spectrum, while other embodiments operate in the optical spectrum.

By separating the host function of components from their waveguide/resonator functions, embodiments of the present invention provide easy coupling to existing state-of-the-art optical/microwave devices. Furthermore, the separation of functions allows improved control and optimization of gain media and quantum emitters.

Platforms according to embodiments of the present invention, as described herein provide a basis for design and construction of improved lasers, amplifiers, sensors, quantum sources, nonlinear optical elements, non-limiting examples of which include saturable absorbers or filters, and optical sensors. According to various embodiments, improvements include, but are not limited to: narrower frequency spread; and higher gain. For quantum technologies, embodiments of the invention provide lanthanide complexes on tapered optical fibers for quantum photonic memories, which are crucial building blocks of quantum repeaters necessary for quantum communication and teleportation protocols. Related embodiments provide lanthanide complexes for photon quantum memories and for repeaters in superconducting circuits, as well as for optical quantum memory and as repeaters; either as single complexes coupled to whispering gallery mode (WGM) resonators or as ensemble of lanthanide complexes coupled to an optical/microwave waveguide.

In addition, lanthanide complexes according to embodiments of the present invention provide coupling to both optical and microwave fields, to serve in protocols for bi-directional coherent conversion of single photons (and qubits) between the optical and the microwave domains—a highly sought-after goal in quantum information processing.

Therefore, according to embodiments of the present invention there is provided a quantum device comprising at least one solid surface and a lanthanide complex; wherein the lanthanide complex is adsorbed on the solid surface or the solid surface is coated by the covalently bound lanthanide complex; wherein the lanthanide complex includes a lanthanide ion having an f-f transition.

### BRIEF DESCRIPTION OF THE DRAWINGS

The subject matter disclosed may best be understood by reference to the following detailed description when read with the accompanying drawings in which:

FIGS. 1A and 1B conceptually illustrate multilayered structure based on a lanthanide complex on the surface of a device according to embodiments of the present invention. FIG. 1A illustrates a non limiting example of a monolayer ligand to be used for the lanthanide complexes. FIG. 1B illustrates a non limiting example of a multilayer structure based on a lanthanide complex. Ln³⁺ refers to any Lanthanide trivalent ion.

FIG. 2 conceptually illustrates quantum device structures and bonding locations for Lanthanide molecular complexes according to embodiments of the present invention.

FIGS. 3A and 3B display results with a tapered fiber coated with Yb[ZnQHA_{MC}]) complexes (synthesized according to the synthesis described in Trivedi, E. R., et al. Highly Emitting Near-Infrared Lanthanide ‘Encapsulated Sandwich’ Metallacrown Complexes with Excitation Shifted Toward Lower Energy. J. Am. Chem. Soc. 136, 1526-1534 (2014).) at room temperature. The excitation spectrum is shown in FIG. 3A, and fluorescence signal at 979 nm with a decay time constant of 11.35 μs is shown in FIG. 3B.

FIG. 4 illustrates time decay constants of YbQHA {Yb³⁺[Zn(II)QHA_{MC}]} on a tapered fiber, at 298K and low pressure, featuring the longest decay time constant of 700 μs.

FIG. 5 illustrates excitation spectra of YbQHA {Yb³⁺[Zn(II)QHA_{MC}]} at different temperatures and pressures.

FIG. 6 illustrates excitation spectra of YbQHA {Yb³⁺[Zn(II)QHA_{MC}]} at different temperatures and pressures.

FIG. 7 illustrates time decay of a commercial Yb doped fiber.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION OF THE PRESENT INVENTION

Embodiments of the present invention feature structures serving as waveguides, resonators, and like devices coated with molecular complexes containing lanthanide ions. In certain embodiments of the invention, the complexes include ligands (as caging molecules) selected to minimize the ion's non-radiative decay channels (including, but not limited to effects such as phononic broadening/decoherence).

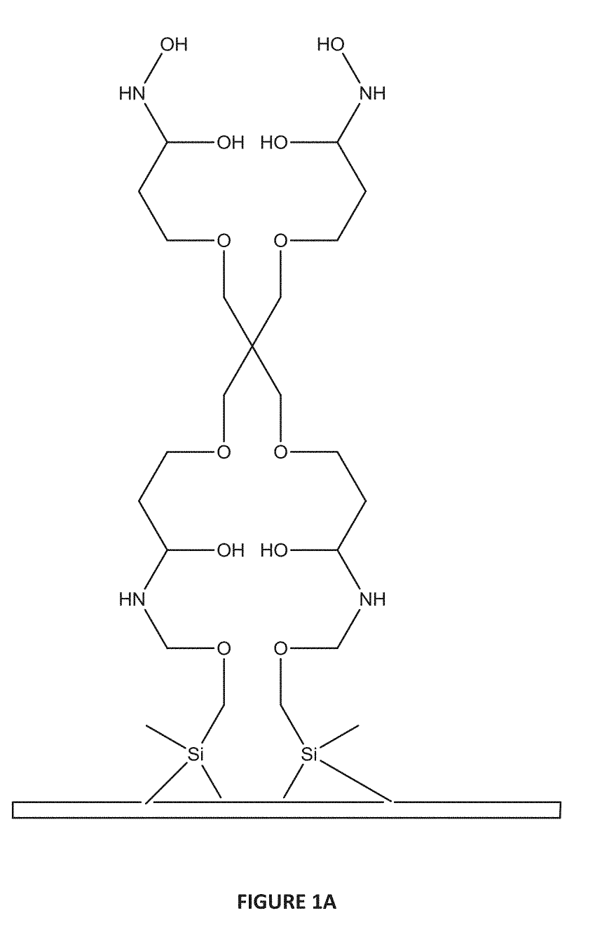

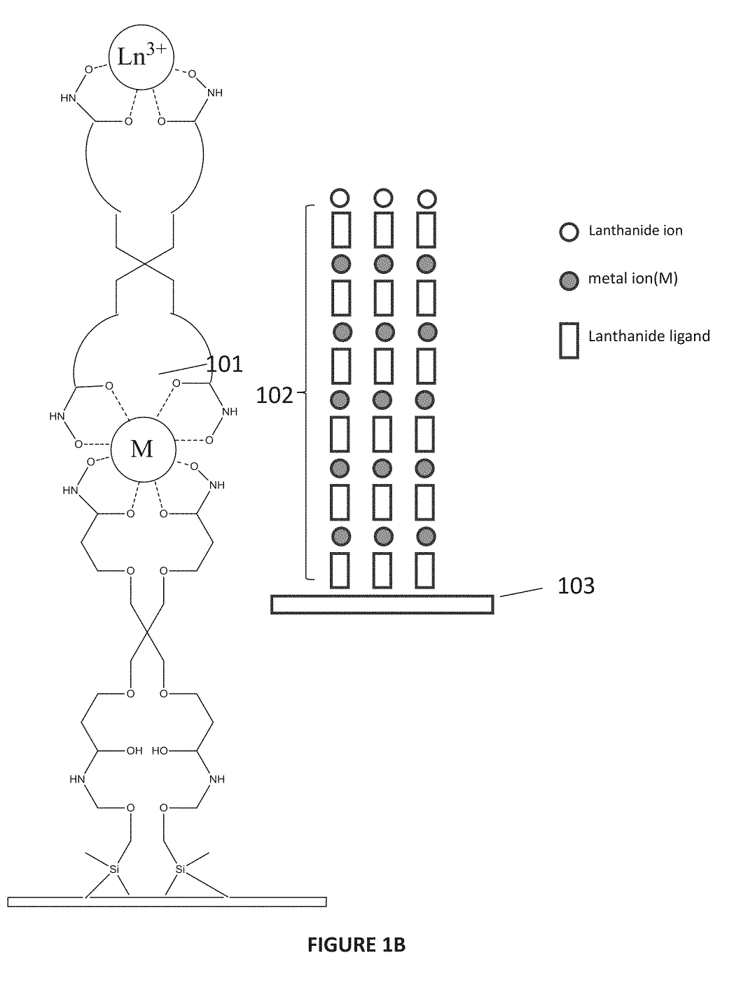

In some embodiments the lanthanide complexes of this invention include one or more lanthanide ions. In other embodiments the lanthanides exhibit intra 4f transitions at different oxidation states (+2, +3 or +4). In other embodiments the lanthanide ion is selected from La, Ce, Pr, Nd, Pm, Sm, Eu, Gd, Tb, Dy, Ho, Er, Tm, Yb, Lu and any combination thereof. In other embodiments, the lanthanide ion is selected from La²⁺, Ce³⁺, Ce²⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺, Lu⁴⁺ and any combination thereof. Each represents a separate embodiment of this invention. In other embodiment, the lanthanide complex of this invention includes a lanthanide ion and a ligand. In other embodiments, the lanthanide ligand is an organic or an inorganic ligand. In other embodiments the organic ligand includes an oxygen, sulfur, phosphrous and/or nitrogen based binding site, wherein the oxygen and/or the nitrogen, and or the sulfur and or the phosphorus atoms bind the lanthanide ion. In another embodiment, the lanthanide ligand is as presented in FIGS. 1A and 1B. In other embodiments, non limiting examples of lanthanide complexes of this invention include: YbCl_{3(MeOH sol)}. Yb(acetylacetonato)_{3 (MeoH sol)}, Yb (Hexafluoroacetylacetonato)_{4(MeoH sol)}, Yb(deuterated Hexafluoroacetylacetonato)₄⁻_{(MeOH} sol), Yb(Heptafluoroacetylacetonato)₂⁺_{(MeOH sol)}, Yb[Zn(II) quinaldichydroxamate metallacrown]_{(MeOH sol)}.

In the descriptions and drawings, non-limiting examples are provided as illustrations the present invention. In particular, the trivalent Ytterbium ion is shown as a representative lanthanide. It is understood, however, that these examples and the specific species discussed are presented as illustrative examples only, and do not limit the scope of the present invention.

FIGS. 1A and 1B conceptually illustrate such an arrangement. According to an embodiment of the present invention, a pre-determined number of metal-organic building blocks binds a lanthanide ion (101) and form a multilayered structure (102) on a solid surface (103) such as a SiO₂ surface of a quantum device or gain medium at a pre-determined distance. A representative metal-organic building block group (as presented in FIG. 1A) has a typical size of about 1.6 nm and has a metal ion (not explicitly shown—non-limiting examples of which include Zr⁴⁺ and Ce₄₊), and includes a silyl group binding to SiO₂ surface.

In related embodiments, molecular complexes can be deposited on surfaces as multi-layers, or grown on surfaces as constructed crystals, or to coat the surface by any known process known in the art (spin coating, vapor deposition etc.). According to these related embodiments, such constructed crystals exhibit considerably greater order than doped crystals, because each lanthanide ion is surrounded by the identical unit cell having the same orientation. Furthermore, the unit cells are optimized for the lanthanide ion and are large (>1 nm unit cell).

In various embodiments, other properties of the lanthanide complexes include the ability to shift the wavelength of the optical transition; and to dramatically increase fluorescence lifetime.

To increase fluorescence lifetime, it is important to note that, for frequencies as high as ⅓ of the optical frequency, vibration of hydrogen atoms is the main mechanism of non-radiative decay, requiring only a 3-phonon process. Therefore, according to embodiments of the invention, structural aspects of molecular complexes reduce non-radiative decay by the use of features including, but not limited to: binding the lanthanide ion to relatively heavy atoms keeping hydrogen atoms as far away as possible; and/or replacing hydrogen with other atoms, non-limiting examples of which include deuterium, oxygen, nitrogen, metal ions and fluorine. In embodiments of the invention, such features decrease electro-vibrational coupling by at least an order of magnitude. As shown in the following table, use of Ytterbium Zinc Metallacrown Quinaldic-hydroxamic acid complexes (Yb[Zn(II)QHA_{MC}]) in solution, in embodiments of the invention attains linewidths <4 nm and fluorescence decay time constants of up to approximately 3.7 μsec at room-temperature.

Yb³⁺[Zn(II)QHA_{MC}] was synthesized first by Pecoraro et al. [J. Am. Chem. Soc., 2014, 136 (4), pp 1526-1534]. Yb³⁺[Zn(II)QHA_{MC}] is a well isolating cage for vibrations. It consists of a 3 rings structure which are based on relatively heavy atoms—zinc, nitrogen and oxygen, so the excited state is not easily quenched. The closest hydrogen atom is 5 bonds from the Yb ion.

The molecule itself strongly absorbs at 380-420 nm and then undergoes energy transfer to the Yb ion to fluoresce in the NIR. This property makes the preliminary detection of the presence of the molecules on the surface easier.

TABLE 1
Some Lanthanide Ion Molecular Complex Decay Time Constants

| Compound | τ (nsec) |
|---|---|
| YbCl₃ | 387 ± 28 |
| Yb(AA)₃ | 1082 ± 18 |
| Yb(HFAA)₄ | 1137 ± 10 |
| Yb(HFAA-d)₃ | 1531 ± 23 |
| Yb(HPFA)₂ | 1081 ± 48 |
| Yb[ZnQHA_{MC}] | 3720 ± 16 |

The data in Table 1 is for Yb³⁺ fluorescence times, in methanol solutions of different chelates at room temperature, using direct excitation of Yb³⁺ (not through the chelate).

According to embodiments of the present invention, tailored lanthanide complexes adsorbed on the surface of a waveguide or resonator are strongly coupled to electromagnetic waves through evanescent fields. In certain related embodiments, the waves are in the optical domain, and in other certain embodiments the waves are in the microwave domain. In still other embodiments, the lanthanide complexes are in crystals grown on, and bonded/adsorbed to, the surface.

In certain embodiments, the lanthanide complexes have a site that directly binds to surfaces such as silica or metal. In other embodiments, the adsorption to the surface involves coating with a controlled number of monolayers of the lanthanide complex, thereby forming the ordered crystal as previously described. According to these embodiments, electromagnetic waves are coupled to the lanthanide complexes via evanescent fields.

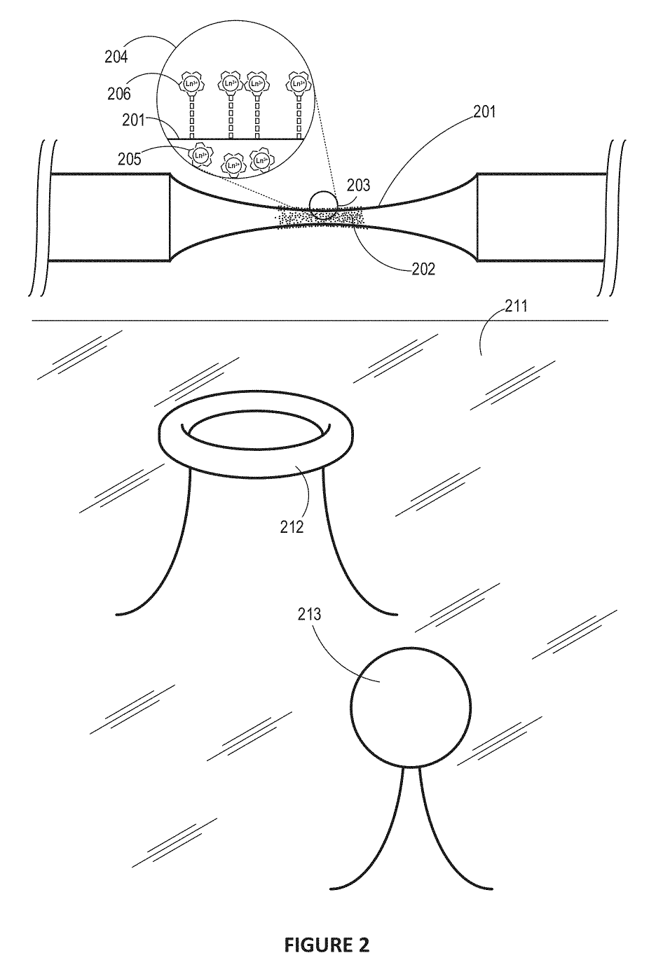

FIG. 2 conceptually illustrates the placement of lanthanide complexes 202 on a tapered microfiber waveguide surface 201 according to an embodiment of the invention. A region 203 is shown in an enlarged view 204 with representative lanthanide complexes 205 (seen from above), and 206 (seen from the side, with metal-organic block group as illustrated in FIGS. 1A and 1B). In another embodiment of the invention, lanthanide complexes are applied to the surface of a micro-toroid whispering-gallery-mode (WGM) resonator 212; and in a related embodiment to a WGM microsphere resonator 213—both on a device surface 211. According to embodiments of the present invention, surface binding of lanthanide complexes results in minimal degradation of the resonator Q-factors.

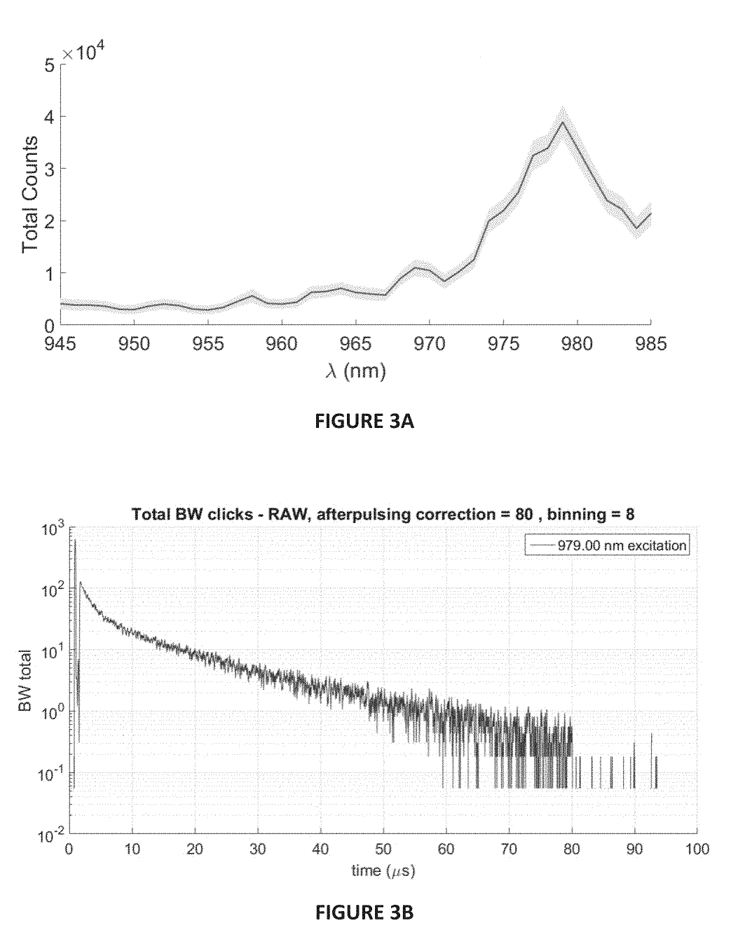

FIG. 3 provides experimental results both in optical and microwave domain. The spectrum is shown in FIG. 3A, is a fluorescence signal at 979 nm with decay constants of 11.35 μs as shown in FIG. 3B.

According to Pecoraro et al. [J. Am. Chem. Soc., 2014, 136 (4), pp 1526-1534] another non radiative channel involves solvent molecules, water and methanol in particular, ligating on the zinc ions of the metallacrown complex. They showed one order of magnitude extension of the lifetime by switching from methanol to deuterated methanol by sensitization through the ligand (14.88 μs to 150.7 μs). The inventors took this further and put the tapered fiber, covered with YbQHA complexes inside a vacuum chamber. By reaching pressure of up to 3*10−4 mbar, it is assumed that the solvent molecules have evaporated. Conducting the same fluorescence experiment in these conditions, resulted in extension of the fluorescence lifetime to approximately 700 μs-1.5 orders of magnitude by direct excitation of the Yb ion in the complex.

In another embodiment, chemical binding of the modified molecules of this invention on the surface of the tapered fiber will be done.

In one embodiment, by carefully modifying the complex, its lifetime can be extended up to the lifetime of commercial doped fibers.

TABLE 2
Fluorescence lifetimes Yb³⁺[Zn(II)QHA_{MC}] on a tapered fiber at different
conditions, in comparison with commercial Yb doped fiber.
Excited on resonance

| Compound | Lifetime (μs) |
|---|---|
| Yb doped fiber (Thorlabs-Liekki) | 147, 836 |
| YbQHA 1 atm, RT | 1.6, 6.1, 21 |
| Yb QHA, 1 atm, 77K | 7, 16, 27 |
| YbQHA, 3 μbar, RT | 10, 147, 700 |

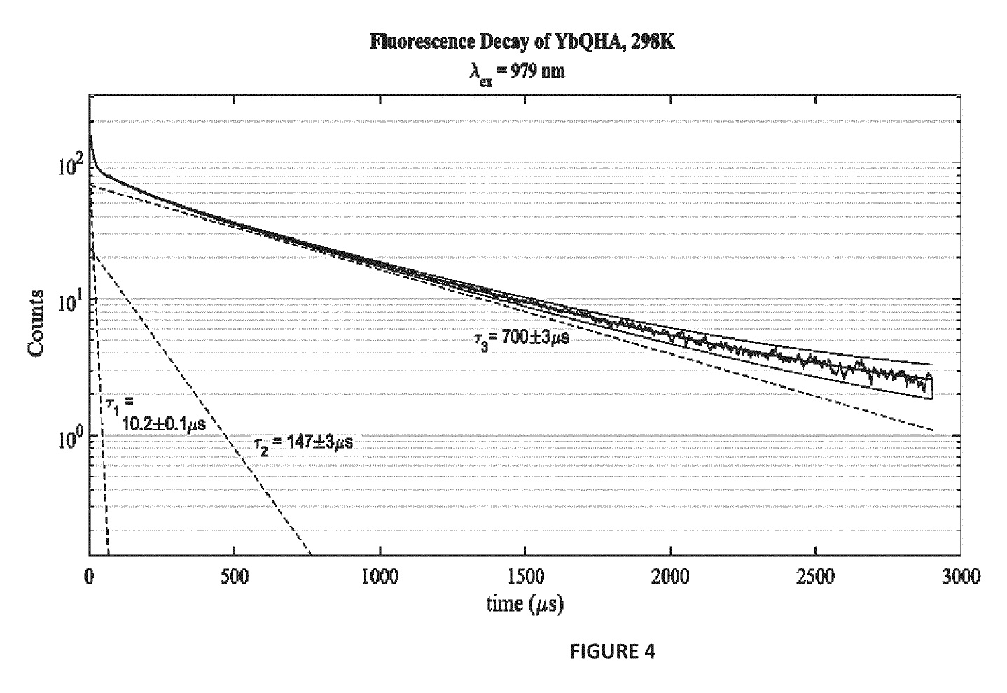

FIG. 4 demonstrates decay constants of YbQHA {Yb³⁺[Zn(II)QHA_{MC}]} on a tapered fiber, at 298K low pressure featuring longest decay time constant of 700 μs.

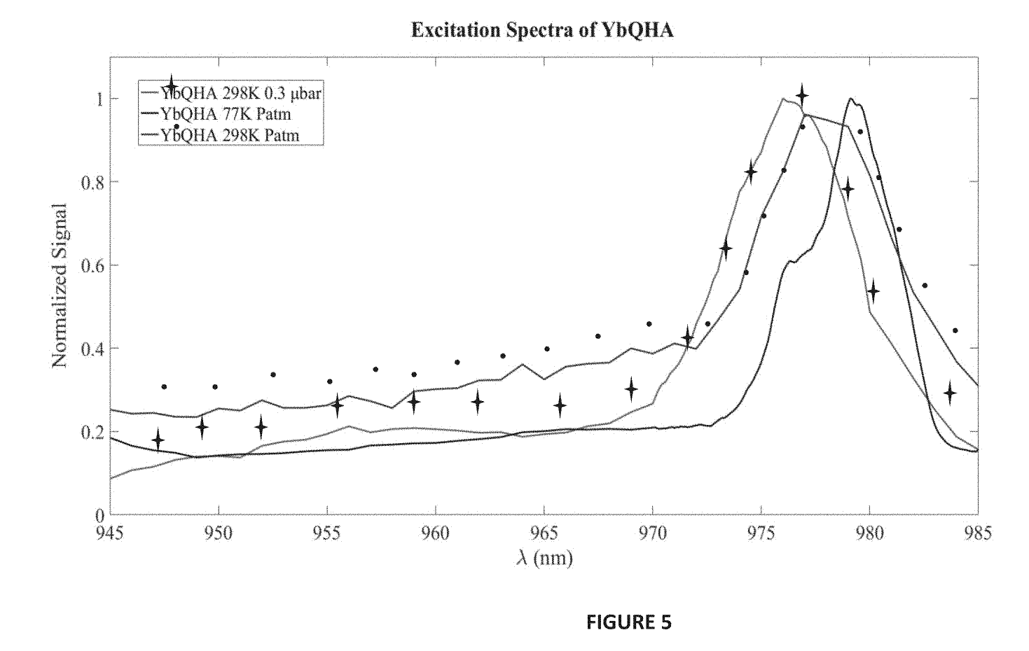

FIG. 5 demonstrates excitation spectra of YbQHA {Yb³⁺[Zn(II)QHA_{MC}]} at different temperatures and pressures.

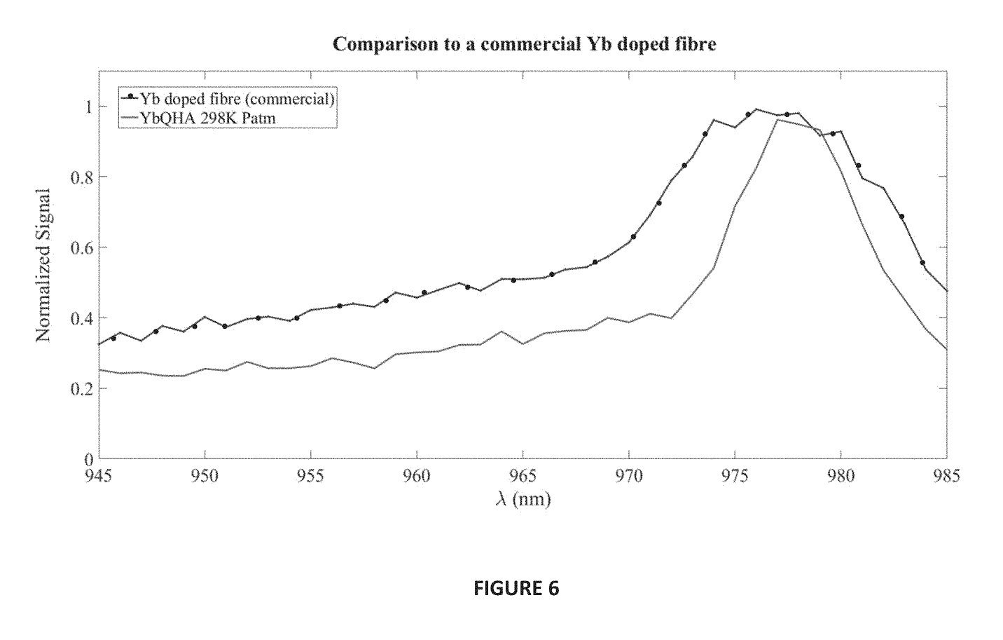

FIG. 6 demonstrates excitation spectra of YbQHA {Yb³[Zn(II)QHA_{MC}]} at different temperatures and pressures.

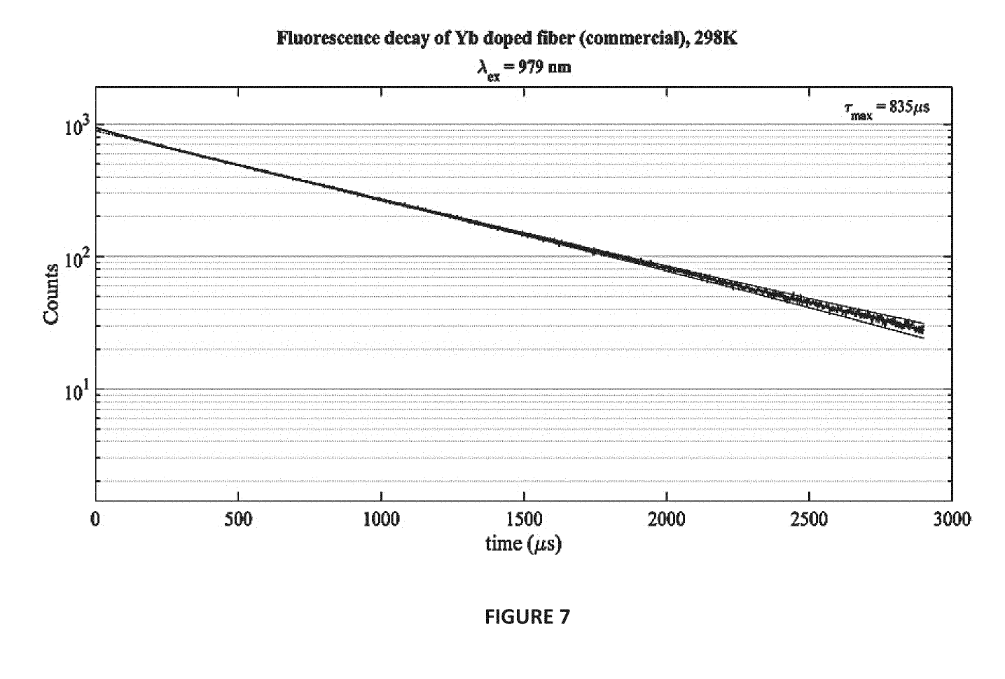

FIG. 7 demonstrates a decay of commercial Yb doped fiber.

In another embodiment of the invention, a microresonator is covered with Lanthanide complexes to benefit from the Purcell enhancement of fluorescence, which results from the increased density of final states in the microresonator.

In an additional embodiment of the invention, the thickness of a constructed crystal or multilayer structure (as illustrated in the non-limiting example shown in FIG. 1B) is adjusted to optimize the distance of the lanthanide ion above solid surface 103.

Coupling a WGM resonator to a single Yb³⁺ ion located inside a molecule bound to the surface in the optical mode. In a further embodiment of the invention, a single lanthanide ion is contained inside a molecule bound to the surface of a WGM resonator in the optical mode. In this configuration, the single Yb³⁺ ion is coupled to the resonator.

In some embodiments this invention provides a quantum device comprising at least one solid surface and a lanthanide complex; wherein the lanthanide complex is adsorbed on the solid surface or the solid surface is coated by the lanthanide complex; wherein the lanthanide complex includes a lanthanide ion having an f-f transition. In other embodiment, the device is a waveguide, a resonator, an amplifier, a sensor, an optical fiber or a laser. In other embodiments, the device operates in the microwave spectrum. In other embodiments, the device operates in the optical spectrum. In other embodiments, the resonator is a whispering gallery mode (WGM) resonator, a micro-toroid or a microsphere.

The platform described here could be used to design and construct better (e.g. narrower in frequency or higher gain) lasers, amplifiers, sensors, and sources, nonlinear optical elements such as saturable absorbers or filters, and optical sensors. For quantum technologies, lanthanide complexes on tapered optical fibers could be used to create quantum photonic memories, which are the crucial building block of quantum repeaters necessary for quantum communication and teleportation protocols. Lanthanide complexes can be used as quantum memories, and as repeaters for microwave photons in superconducting circuits. Single complexes coupled to WGM resonators can be used as material qubits for quantum information processing.

Finally, as these complexes couple to both optical and microwave fields, they can serve in protocols for the bi-directional coherent conversion of single photons (and qubits) between the optical and the microwave domains

What is claimed is:

1. A quantum device a quantum device comprising at least one solid surface and a lanthanide complex; wherein the lanthanide complex is adsorbed on the solid surface or the solid surface is coated by the lanthanide complex; wherein the lanthanide complex includes a lanthanide ion having an f-f transition.

2. The quantum device of claim 1, wherein the device is a waveguide.

3. The quantum device of claim 1, wherein the device is a resonator.

4. The quantum device of claim 1, wherein the device is an amplifier.

5. The quantum device of claim 1, wherein the device is a laser or a sensor.

6. The quantum device of claim 1, wherein the device operates in the microwave spectrum.

7. The quantum device of claim 1, wherein the device operates in the optical spectrum.

8. The quantum device of claim 1, wherein the lanthanide complex comprises an organic ligand.

9. The quantum device of claim 8, wherein the ligand comprises a silyl group to bind to a solid surface.

10. The quantum device of claim 1, wherein the lanthanide complex is grown on the at least one surface as a constructed crystal.

11. The quantum device of claim 2, wherein the device is an optical fiber.

12. The quantum device of claim 3, wherein the resonator is a whispering gallery mode (WGM) resonator.

13. The quantum device of claim 12, wherein the resonator is a micro-toroid.

14. The quantum device of claim 12, wherein the resonator is a microsphere.

15. The quantum device of claim 12, wherein the lanthanide ion is La³⁺, Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺, Lu³⁺ or any combination thereof.

16. The quantum device of claim 10, wherein the thickness of the constructed crystal is adjusted to optimize a distance of the lanthanide ion above the solid surface.

17. The quantum device of claim 12, wherein the lanthanide ion is a single ion.

18. The quantum device of claim 17, wherein the single lanthanide ion is inside a molecule bound to the surface of the WGM resonator.
